(19) United States
(12) Patent Application Publication
(10) Pub. No.: US 2017/0300903 A1
(43) Pub. Date: Oct. 19, 2017

(54) SYSTEM AND METHOD FOR NETWORK TRANSACTION PROCESSING USING THROTTLING ENGINE

(71) Applicants: MICHAEL MORI, SAN MATEO, CA (US); GOURAB BASU, HALF MOON BAY, CA (US); STEVE CRACKNELL, SAN MATEO, CA (US)

(72) Inventors: MICHAEL MORI, SAN MATEO, CA (US); GOURAB BASU, HALF MOON BAY, CA (US); STEVE CRACKNELL, SAN MATEO, CA (US)

(21) Appl. No.: 15/235,948

(22) Filed: Aug. 12, 2016

Related U.S. Application Data
(60) Provisional application No. 62/322,739, filed on Apr. 14, 2016.

(51) Int. Cl. G06Q 20/40; G06Q 10/06; G06Q 20/10; G06Q 40/08

(52) U.S. Cl. CPC G06Q 20/401; G06Q 40/08; G06Q 10/067; G06Q 20/102

(57) ABSTRACT

Embodiments of the invention are directed to a transaction decisioning system implemented by a payment processing network that helps mitigate the payment processor's financial risk. One way the transaction decisioning system mitigates the financial risk is by limiting the number of transactions a client can approve in comparison to a calculated risk threshold.

### CROSS-REFERENCE TO RELATED APPLICATIONS

This application is a non-provisional of and claims the benefit of the filing date of U.S. Provisional Application No. 62/322,739, filed on Apr. 14, 2016, which is herein incorporated by reference in its entirety for all purposes.

### BACKGROUND

Conventional payment processing systems can include a merchant, an acquirer, a payment processing network, and an issuer. In a typical payment transaction where a user purchase a good from a merchant using a payment card, the merchant can generate an authorization request message with a transaction amount. This message may be transmitted to the issuer via the acquirer and payment processing network. The issuer may be a bank that issues a payment card to the user. If the transaction is approved by the issuer, an authorization response message may be transmitted from the issuer to the merchant via the acquirer and the payment processing. At a later point in time, the transaction is settled through the payment processing network. Actual funds are transferred from the issuer to the acquirer and then to the merchant's account.

In the conventional payment transaction system, there is always a chance that one or more issuers may not be able to fulfill its settlement obligations. There may be a variety of reasons for this including poor managements of its assets, technical difficulties, etc. If an issuer is unable to fulfill its settlement obligations, then this can be disruptive to the payment processing system and result in more computing power being expended to rectify the issuer's failure. For example, an authorization might be routed to the issuer for settlement, which would then be added to the issuer's settlement obligations totals. Since the issuer is unable to pay the obligation, the funds transfer instruction by the settlement agent would fail. For payment processors that indemnify the payment, the payment processor might then instruct the settlement agent to initiate a new funds transfer instruction for the amount from a different settlement account (e.g., one associated with the payment processor). The payment processor would then instruct the financial institution that manages the issuer's collateral to fund the payment processor's settlement account from the collateral in the amount of the failed instruction.

Embodiments of the invention address this and other problems, individually and collectively.

### BRIEF SUMMARY

Embodiments of the present invention relate to systems and methods for minimizing disruption in a payment processing system that may be caused by unexpected events such as the involvency or an unexpected decline in the creditworthiness of an issuer. Embodiments of the invention can also minimize a payment processor's risk associated with guaranteeing electronic payment transactions (e.g., via a payment indemnification clause) authorized by issuers. In some cases, payment processors may guarantee payment transactions for merchants if issuers are unable to settle transactions that have been authorized by those issuers.

One embodiment of the invention is directed to a method comprising determining, by a computer, an amount of collateral associated with a participation in a program by a financial institution, calculating, by a computer, a risk threshold value for the financial institution based at least in part on the amount of collateral, and declining, by a computer, authorization request messages from a payment processing network when an aggregate amount of previously-authorized transaction amounts exceeds the risk threshold value.

Another embodiment of the invention is directed to a computer comprising a processor, and a computer readable medium coupled to the processor. The computer readable medium comprises code, executable by the processor to cause the processor to determine an amount of collateral associated with a participation in a program by a financial institution. The computer readable medium comprising additional code to cause the processor to calculate a risk threshold value for the financial institution based at least in part on the amount of collateral. The computer readable medium comprising additional code to cause the processor to decline authorization request messages from a payment processing network when an aggregate amount of previously-authorized transaction amounts exceeds the risk threshold value.

These and other embodiments of the invention are described in further detail below.

### BRIEF DESCRIPTION OF THE DRAWINGS

FIG. 1 shows a block diagram of a system according to an embodiment of the invention.

FIG. 2 is a graph illustrating aggregated authorizations for a client according to an embodiment of the invention.

FIG. 3A is a graph illustrating the calculation of a current exposure position according to an embodiment of the invention

FIG. 3B is a graph illustrating the calculation of current exposure position at the end of a next processing day according to an embodiment of the invention

FIG. 4 is a graph illustrating daily payment obligations that are not indicative of suspicious activity, but represent higher transaction volumes than usual according to an embodiment of the invention.

FIG. 5 is a graph illustrating daily payment obligations that may be indicative of suspicious activity according to an embodiment of the invention.

FIG. 6 is a computer architecture according to an embodiment of the invention.

### DETAILED DESCRIPTION

Payment processors may assist its clients (e.g., acquirer banks) by indemnifying payment transactions, irrespective of the processing network used for the transaction. The indemnification can be a promise by the payment processor to provide necessary funding for unpaid obligations on behalf of the client, which potentially absolves a client's obligation to settle the payment. The indemnification may be necessary to reimburse its clients for losses incurred when another financial institution is unable to fulfill its payment obligations (e.g., when an issuer bank becomes insolvent).

Payment processors can provide these indemnifications for a variety of reasons. Some payment processors may use the indemnifications to increase sales penetration and market share by accepting all payment transactions from clients with riskier credit ratings or clients in developing economies. These payment processors may not collect collateral, like liquidity (e.g., cash), or may relax collateral requirements to attract these clients' business. However, by not collecting collateral to cover a substantial amount of the client's payment obligations (e.g., previously-authorized transaction amounts), these payment processors can potentially be liable for significant financial obligations if the client is unable or unwilling to pay its settlement obligations.

Other payment processors may choose to collect collateral from these riskier clients in exchange for the indemnification. For example, the payment processor may request collateral before the payment processor indemnifies the client's payment transactions. The amount of collateral may be based on standard collateral requirements such as credit ratings. In the event that the payment obligation exceeds the collateral held by the payment processor, the payment processor can recoup funds from a collateral account and/or from an international settlement account. However, when the client's payment obligation exceeds the collateral and the international settlement account, the payment processor may be exposed to excess financial risk.

Further, the indemnifiers (e.g., the payment processors that indemnify electronic payment transactions) may carry financial risk in several scenarios after a typical payment transaction has concluded and authorization and clearing processing has begun. For instance, such scenarios may include:
Neither authorization nor clearing is processed by the indemnifier;
Authorization is processed by the indemnifier and clearing is processed by a payment processor other than the indemnifier;
Authorization is processed by a payment processor other than the indemnifier and clearing is processed by the indemnifier; or
Both authorization and clearing are processed by the indemnifier.

Thus, there exists a need for payment processors to efficiently minimize the risk in indemnifying payments, for example, when authorization and clearing are processed by the indemnifier. In addition, there is a need to prevent or preclude the additional transaction processing (e.g., transaction reversals) that might be associated when issuers do not fulfill their settlement obligations.

Embodiments of the invention are directed to a transaction decisioning system. The transaction decisioning system can help mitigate a payment processor's financial risk by dynamically and automatically limiting the number of transactions an issuer can approve. The payment processor can first collect collateral from the issuer and register the issuer in its transaction decisioning system. The transaction decisioning system can monitor the issuer's payment transactions (e.g., authorizations) that it passes through the payment processing network. When the transactions are run through the payment processing network, the transaction decisioning system may add the corresponding financial obligation to a record associated with the issuer's total financial obligation (e.g., the client's current exposure position). When the financial obligation of the issuer reaches a predefined throttling threshold value, based at least in part on the collateral amount, the transaction decisioning system can throttle authorization messages (e.g., decline transactions) using various user-specified parameters to mitigate the payment processor's financial risk exposure. For example, the transaction decisioning system can decline automated teller machine (ATM) transaction while still allowing point-of-sale (POS) transactions. In another example, risky transactions (denoted by a risk score equal to or exceeding a risk threshold) may be declined, while safer transactions (denoted by a risk score that is less than a risk threshold) are allowed. As yet another example, transactions corresponding to certain merchant types (e.g., grocery, gasoline, etc.) may be allowed while transactions with other merchant types are declined.

Similarly, the transaction decisioning system may monitor the issuer's total financial obligation with respect to an alerting threshold (e.g., a threshold that may be the same or different than the throttling threshold). When the issuer's total financial obligation reaches or exceeds the predefined alerting threshold, the transaction decisioning system can provide one or more notifications (e.g., email, text, etc.) to the payment processor to alert the payment processor of the situation.

In still further examples, the transaction decisioning system may monitor the issuer's total financial obligation with respect to a maximum risk threshold (e.g., a threshold that may be the same or different than the throttling threshold and/or the alerting threshold). When the issuer's total financial obligation reaches or exceeds the predefined declining threshold, the transaction decisioning system can decline all future transactions for the issuer.

For example, the payment processor may estimate that the amount of collateral that is required for a small bank is $10 million. If the small bank can only provide 50% of the requested collateral, then the payment processor can limit the amount of money associated with the authorizations that it allows so that the payment processor is not at risk in indemnifying the payments. That is, if the transaction obligations exceed $5 million for customers associated with the small bank, the payment processor can begin to decline the authorization of transactions. Accordingly, in this example, the declining threshold value may be set to $5 million, a throttling threshold value may be set to $4.5 million, and an alerting threshold value may be set to $4 million. Adjustments of these threshold values may be dynamic in nature. By alerting the payment processor to the fact that the issuer has reached a particular amount in transaction obligations, the transaction decisioning system provides the payment processor the ability to take action before the issuer's transactions are throttled/declined. By throttling and/or declining these transactions, the payment processor can avoid financial liability for indemnifying the payments and potentially lose the fees associated with processing the transactions. Further, by throttling and/or declining some or all transactions, additional payment transaction processing need not take place. For example, declining some or all transactions because the issuer has met or exceeded a threshold (e.g., a declining threshold) can reduce the number of messages required to settle those transactions. Accordingly, an authorization need not be routed to the issuer for settlement. Additionally, messages that may have been exchanged between a payment processor and a financial institution that manages an issuer's collateral would no longer be required. Instead, the transaction can be declined, negating the need for these additional messages to be processed.

In at least one embodiment, a risk quotient may be calculated that quantifies a risk associated with a issuer. The risk quotient may be used to determine appropriate values corresponding to an alerting threshold value, a throttling threshold value, and/or a declining threshold value. In at least one example, the risk quotient (and thus, the corresponding alerting, throttling, and/or declining threshold values) can be calculated in part on the collateral amount, and in part on such factors as the client's credit rating, liquidity, or whether the client is based in a developing country.

Before discussing detailed embodiments of the invention, some descriptions of certain terms may be useful.

A “computing device” may be any suitable device that can perform computations, and that can communicate with other devices. A mobile device is an example of a computing device. Other types of computing devices may not be mobile.

A “mobile device” may comprise any electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, personal music players, hand-held specialized readers, wearable devices (e.g., watches), vehicles (e.g., cars), etc. A mobile device may comprise any suitable hardware and software for performing such functions, and may also include multiple devices or components (e.g., when a device has remote access to a network by tethering to another device—i.e., using the other device as a relay—both devices taken together may be considered a single mobile device).

An “authorization request message” may be an electronic message that is used to authorize a payment for a financial transaction. In some examples, an authorization request message is sent to a payment processing network and/or an authorizing computer to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV(card verification value), a dCVV (dynamic card verification value), an expiration date, etc.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Refer to Issuer—response pending more information, merchant must call the toll-free authorization phone number. The authorization response message may also include an authorization code, which may be a code that a payment card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

A “client risk profile” may be a record of a client (e.g., an issuer) that includes historical transactions associated with the client. For example, the client risk profile may include all transactions associated with the client, or a number of transactions associated with the client over a period of time (e.g., the last 12 months, the last 5 years, the last week, etc.). The client risk profile may also store aggregated amounts related to the client's financial obligations (e.g., daily aggregated amounts, a total of several daily aggregated amounts over a particular time period, etc.). The historical transactions stored in the client risk profile may include domestic and/or international transactions. In an embodiment, the client risk profile can also include data about the client's payment practices, including average elapsed time between authorization and submission of clearing files, or performance metrics related to the settlement agent. For example, the metrics related to the settlement agent can be how quickly the settlement agent initiates a fund transfer or how quickly the payment processor is notified of a failed or overdrawn transfer. Further, embodiments of the client risk profile may be flexible to accommodate varying levels of information availability, differing banking practices, and other region or country-specific practices.

A “risk quotient” is a score that corresponds to a degree of risk associated with an entity (e.g., a client). For example, a score of 1 out of 100 may indicate a very low risk, while a score of 100 out of 100 may indicate an extremely risky client situation. A risk quotient can be modeled and updated in real time as information becomes available, causing the monitoring system to dynamically adjust thresholds accordingly. In other embodiments, the risk quotient method can be abandoned and the thresholds can be statically set using absolute values (e.g., alert at $500K, throttle at $600K, and max decline at $700K). As discussed above, a model may be utilized, along with data from sources such as regulatory bodies/ratings agencies and historical transaction data (e.g., a client risk profile) to determine a risk quotient for a client. The model may calculate a risk quotient for the client based on a number of factors, including, but not limited to an amount of capital, asset quality, client liquidity, client collateral, and the like. In at least one example, the model may include transaction history (both domestic and cross-border) from multiple sources including the payment processor's processed transactions and operating certificates. The model can also include acquirer payment practices, including an average elapsed time between authorization and submission of clearing files. The model may also incorporate the performance of the settlement agent. The model may also accommodate varying levels of information availability, differing banking practices, and other region or country-specific practices. In at least one embodiment, the model may determine that, based on the capital, asset quality, liquidity, and collateral of a client, a risk quotient of $10 million. Accordingly, the risk quotient may be used to determine at least one of an alerting threshold value, a throttling threshold value, and/or a declining threshold value. Any number of such threshold values may be dynamically and automatically modified as the risk quotient is updated over time. For example, if the client is experiencing financial shocks that increase payment obligation risk, the risk quotient may be updated and one or more of the threshold values can be adjusted accordingly in near real-time.

“Settlement agent performance” can be a value quantifying the performance of a settlement agent. Settlement agent performance may take into account the promptness of funds transfer initiation, timely reporting to a payment processor, and the like. For example, utilizing a relatively quickly reporting settlement agent (with respect to other settlement agents that take longer to report) may impact a client's risk quotient because outstanding obligations would be settled more quickly, resulting in a lower risk quotient and, thus, higher thresholds. In some embodiments, the settlement agent's efficiency can be directly modeled during calculation of one or more of the thresholds discussed herein and imputed into the transaction decisioning system independent of a risk quotient.

A “maximum risk threshold value” may be an amount (e.g., in $ USD) that represents a maximum financial exposure that a payment processor is willing to accept for a particular client. In at least one example, the maximum risk threshold value may be based on an amount of collateral a client has provided. In some examples, it represents a maximum amount that an issuer is allowed to authorize over a period of time (e.g., 3 days) before all further transactions will be declined. In at least one example, once the client's total financial obligations over an ECD (“estimated clearing delay”) of 3 days have met or exceeded the maximum risk threshold value, the transaction decisioning system may automatically cause all future transactions associated with the client to be declined. The maximum risk threshold value may be related to an amount of approved payment authorizations that have yet to be cleared and settled. For example, it may take an average of three days (otherwise referred to as an “estimated clearing delay” (ECD)) between authorization and clearing for a particular client. Accordingly, the maximum risk threshold value may be based on an aggregation of a client's financial obligations over a time period corresponding to the ECD. The maximum risk threshold value can be determined based, at least in part, on a client's risk quotient.

“Authorization throttling” may refer to a process for reducing a number of approved authorization requests for a particular client. In at least one example, throttling authorizations may cause a portion (e.g., 50%, 75%, etc.) of received authorization requests to be declined. In at least one example, the number and/or portion of authorizations to be declined may be according to a predetermined value.

A “throttling threshold value” may be a maximum amount (e.g., in $ USD) an issuer is allowed to authorize before transaction throttling logic is invoked. In at least one example, the throttling threshold value may be based on an amount of collateral a client has provided. In some examples, it represents a maximum amount that an issuer is allowed to authorize over a period of time (e.g., 3 days) before the client's authorizations may be throttled. For example, once the client's total financial obligations yet to be cleared and settled have met or exceeded the throttling threshold value, the transaction decisioning system may cause the number of approved payment authorizations to be reduced by 50%. In another example when the throttling threshold value has been exceeded, the transaction decisioning system can decline one or more transactions based on any suitable combination of a transaction type (e.g., allow ATM transactions but not POS transaction, or vice versa), a transaction risk score (e.g., decline transactions with a risk score over a threshold), a merchant type (e.g., allow transactions with grocery merchant type and gasoline merchant type but decline all others), and/or the like. In some examples, the total financial obligations are determined based on an ECD. Accordingly, the throttling threshold value may be based on an ECD. The throttling threshold value can be determined based at least in part on a client's risk quotient.

An “alerting threshold value” may indicate a maximum amount (e.g., in $USD) that an issuer is allowed to authorize before electronic alerts (e.g., an email, a text message, etc.) may triggered. For example, once the client's total financial obligations that have yet to be cleared and settled have met or exceeded the alerting threshold value, the transaction decisioning system may cause an email to be sent to the payment processor informing the payment processor of the situation. In some examples, the total financial obligations are determined based on an ECD. Accordingly, the alerting threshold value may be based on an ECD. The alerting threshold value can be determined based, at least in part, on a client's risk quotient.

A “current exposure position” may indicate an aggregate of all issuer approved authorization amounts within an ECD period. In at least some examples, this value may be calculated based solely on authorization data. For example, a client may be associated with an ECD of 4 days. If the transactions associated with the client equal $1 million per day for each of the last 4 days, then the client's current exposure position would equal $4 million, indicating that the client's total financial obligations that have yet to be cleared and settled is $4 million.

A “central processing date” (CPD) may be a date used by a system to settle a transaction. In some examples, foreign exchange rates may be calculated using a CPD for multicurrency transactions. In further examples, dispute dates may be designated as starting from this date (e.g., if there are 30 days to dispute a transaction, the start date may be set to the CPD date). In still further examples, settlement of transaction may occur on the CPD. The date may be predefined or may be modifiable.

A “settlement risk group object” may refer to a data structure that stores set of rules used to manage a settlement group (e.g., a group of one or more clients). In at least one example, a settlement risk group object may include at least one data field such as a settlement risk group identifier, a flag to indicate whether domestic transactions must be accumulated separately, a currency indicator for domestic transactions, a cut-off time associated with domestic transactions, an average number of clearing days related to domestic transactions, an average number of clearing days related to international transactions, a monitor domestic exposure indicator, and a monitor non-domestic exposure indicator.

A “settlement risk group identifier” may be an alphanumeric value that is used to associate one or more clients with a settlement risk group object. For example, a settlement risk group object may be associated with a settlement risk group identifier. Additionally, one or more clients may also be associated with the same settlement risk group identifier. Accordingly, when aggregating financial obligations (e.g., calculating a current exposure position) for a client that is associated with a settlement group identifier, the transaction decisioning system may apply the set of rules defined in a settlement risk group object corresponding to that settlement risk group identifier.

A “merchant” may typically be an entity that engages in transactions and can sell goods or services, or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “issuer” may typically refer to a business entity (e.g., a financial institution) that maintains an account for a user. An issuer may also issue payment credentials stored on a user device, such as a cellular telephone, smart card, tablet, or laptop to the consumer.

A “server computer” is typically a powerful computer or cluster of computers. For example, the server computer can be a large mainframe, a minicomputer cluster, or a group of servers functioning as a unit. In one example, the server computer may be a database server coupled to a Web server.

A “processor” may refer to any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

### I. Systems

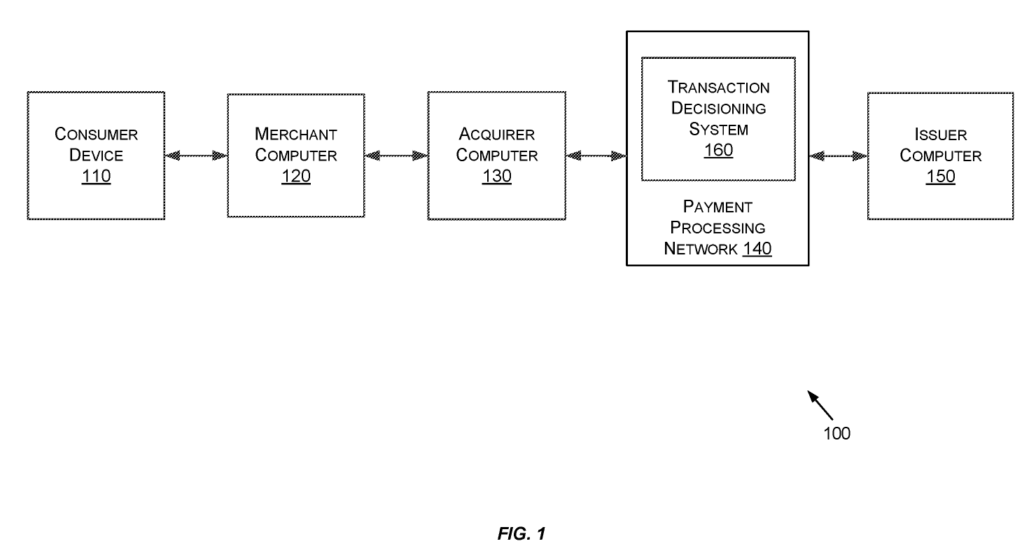

FIG. 1 shows a block diagram of a system according to an embodiment of the invention. The system 100 may comprise a consumer device 110, merchant computer 120, acquirer computer 130, payment processing network 140, and issuer computer 150. In an embodiment, the payment processing network 140 may implement a transaction decisioning system 160.

According to an embodiment, in standard operation, an authorization request message is created during a purchase of a good or service between a consumer device 110 and a merchant computer 120. The authorization request message is typically sent from the merchant computer 120 or merchant's service provider, to the merchant's acquirer computer 130, to a payment processing network 140, and then to an issuer computer 150. An authorization request message can include a request for authorization to conduct a payment transaction and data relevant to determining if the request should be approved or authorized. After the issuer receives the authorization request message, the issuer determines if the transaction should be authorized and sends an authorization response message back to the payment processing network 140 to indicate whether or not the current transaction is authorized. The payment processing network 140 forwards the authorization response message to the acquirer computer 130, then to the merchant computer 120 or merchant's service provider. The merchant is thus made aware of whether the issuer has authorized the transaction, and hence whether the transaction can be completed.

At a later time, a clearance and settlement process may be conducted by the payment/transaction processing system. A clearance process involves exchanging financial details between an acquirer and an issuer to facilitate posting a transaction to a consumer's account and reconciling each party's settlement position. Clearance and settlement can occur simultaneously or as separate processes.

When a transaction decisioning system has been implemented in accordance with an embodiment of the invention, the transaction decisioning system 160 monitors the client's payment obligation (e.g., an issuer's payment obligation), based primarily on authorization data that is flowing through the payment processing network. If the issuer's payment obligation becomes too high (e.g., meets or exceeds a throttling threshold value), the transaction decisioning system 160 can throttle (e.g., decline) at least some authorization response messages from the issuer computer 150. By throttling authorization messages, the transaction decisioning system 160 can mitigate the payment processor's financial risk exposure. Similarly, if the transaction decisioning system 160 detects that the client's payment obligation meets or exceeds a maximum risk threshold value, the transaction decisioning system 160 may decline all future authorization response messages from the issuer computer. Further, if the transaction decisioning system 160 detects that the client's payment obligation meets or exceeds an alerting threshold value, the transaction decisioning system 160 may cause one or more alerts to be sent to the payment processor.

Embodiments of the invention can implement several features in the transaction decisioning system 160 to monitor the payment processor's risk with respect to a particular client. One such feature is a client risk profile. As a component of a larger risk management framework, the client risk profile can provide a summary of a client based on historical information (e.g., a number of past transactions associated with the client). The historical information (and any other suitable information) of the client risk profile may serve as input to a model used to calculate a risk quotient for the client. Additionally, or alternatively, the model may be utilized by the transaction decisioning system 160 to analyze quantitative data (e.g., client's capital, asset quality, liquidity, collateral) from a variety of sources (e.g., regulatory bodies, ratings agencies) in order to output a risk quotient that quantifies the client's risk. The source of the transaction history may include the payment processor network, processed transactions, and operating certificates. Operating certificates may be a mechanism for clients to report certain transaction volumes to the payment processor.

In at least one example, the client risk profile can also include data about the client's (e.g., acquirer's) payment practices, including average elapsed time between authorization and submission of clearing files, or performance metrics related to the settlement agent. For example, the metrics related to the settlement agent can be how quickly the settlement agent initiates a fund transfer or how quickly the payment processor is notified of a failed or overdrawn transfer. Further, embodiments of the client risk profile may be flexible to accommodate varying levels of information availability, differing banking practices, and other region or country-specific practices.

Another feature that may be implemented in embodiments of the invention is a maximum risk threshold value. The maximum risk threshold may be calculated by the transaction decisioning system 160 using the calculated risk quotient and can represent the maximum liquidity that the payment processor is willing to provide pursuant to the payment indemnification.

As a non-limiting example, the risk quotient of the client may be calculated to be 5 out of 100, which may cause the system to set the alerting, throttling, and maximum risk thresholds in proportion to this risk quotient. In this example, since the risk quotient is low, the system may set the maximum risk threshold value to 300% of the collateral amount (or historical daily volume, or other such indicator of transaction activity, or the like), allowing the client to authorize amounts in excess of the collateral. If external information becomes available that causes the client's risk quotient to increase (e.g., indications of insolvency or fraud spike), the quotient may be updated to 80. This updated risk quotient may causes the transaction decisioning system 160 to adjust the maximum risk threshold down to 75% of collateral, for example, to ensure that sufficient funds are available should the client default on settlement obligations. Accordingly, the maximum risk threshold value can quickly be modified by the transaction decisioning system 160 according to changes in the risk quotient. For example, if the client is experiencing financial shocks that increase the payment processor's risk, the risk quotient can be updated and the maximum risk threshold value can be adjusted by the transaction decisioning system 160 in real-time.

In some embodiments of the invention, the risk quotient and/or threshold can be derived externally and/or internally to the transaction decisioning system 160 and supplied as an input parameter to guide the transaction throttling. For example, the transaction decisioning system 160 may accept a maximum risk threshold value (e.g., an amount in the issuer settlement currency) and an estimated clearing delay (ECD) (e.g., the number of days that the issuer experiences between authorization and clearing).

The transaction decisioning system 160 may also calculate an estimated real-time payment obligation (e.g., a current exposure position) for the client. The current exposure position can be based primarily on authorization data that is flowing through the payment processor network. For example, the current exposure position can be quantified by aggregating authorization amounts (e.g., for each day over a ECD) and adjusting for exception items (e.g., reversals, merchandise credits, chargebacks). In an embodiment, the assumption may be made that every approved authorization will be subsequently cleared and settled for the same amount. In some embodiments, clearing data may be used in the calculation. In other embodiments, clearing data may not be used.

In an embodiment, the estimated current exposure position may incorporate actual amounts for exception items from authorization and/or clearing data. When the transaction decisioning system 160 is first initialized, there may be buildup of a client's payment obligations that can affect the current exposure position of a client. This buildup may be comprised of outstanding payment obligations that have not been transmitted or authorized transactions that have occurred since the previous processing cutoff. The estimated buildup amount can be calculated using available data (e.g., transaction history, settlement reporting) and can be added to the client's current exposure position (e.g., seeding the amount).

In an embodiment of the invention, the exception items may be accounted for by incorporating data obtained during the clearing and settlement phase on a client by client basis. In another embodiment, a rate of exception items can be calculated or approximated on a client by client basis. For example, the exception items may account for approximately 1% of transaction volume globally and can be incorporated accordingly.

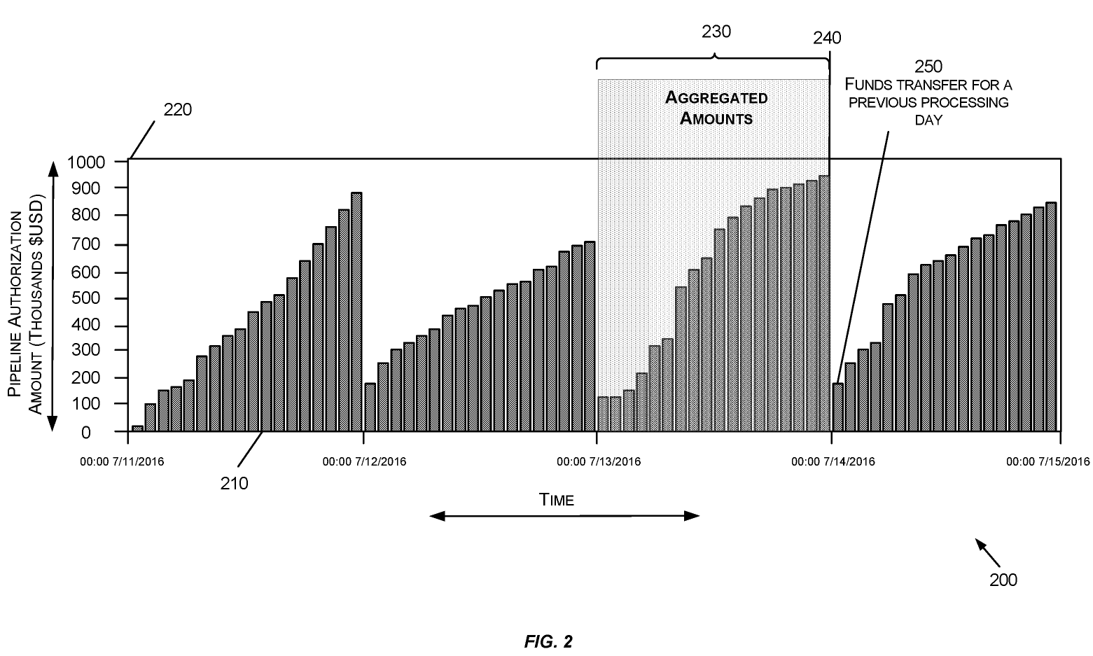

After the fund transfer has calculated the current exposure position of the client, the amount of settled payments and estimated amount of upcoming settled transaction can be removed from the client's aggregated obligation. This removal process may occur either during clearing and settlement, which may happen 30 days after the authorization occurs, or daily. When the removal process occurs during clearing and settlement, the transaction decisioning system 160 would not be able to maintain a real-time calculation of a client's obligation, because it may wait until the aggregated transactions cleared up to 30 days later. When the removal process occurs daily, the transaction decisioning system 160 may not have the benefit of actual settlement values but can implement a real-time estimate of a client's payment obligation. Thus, when the removal process runs daily, the transaction decisioning system 160 can estimate the client's current exposure position by aggregating authorizations and subtracting funds received on a previous processing day, as shown in FIG. 2.

FIG. 2 is a graph illustrating aggregated authorizations for a client according to an embodiment of the invention. The x-axis 210 may correspond to time. The client's aggregated obligation amount can be illustrated on the y-axis 220. A portion of the graph 230 can represent the aggregated amount of payment obligations conducted over the period of a day (e.g., between periodic (e.g., daily) fund transfers by the client). The tallest bar 240 may represent the amount of money of the client's current payment obligation immediately before settlement occurs. After settlement, the graph 200 illustrates the fulfilled payment obligation by showing a shorter bar 250. The shorter bar 250 represents the outstanding payment obligations of the client after the fund transfer. Thus, in an embodiment, the daily fund transfer data can be efficiently used to estimate the client's daily payment obligation.

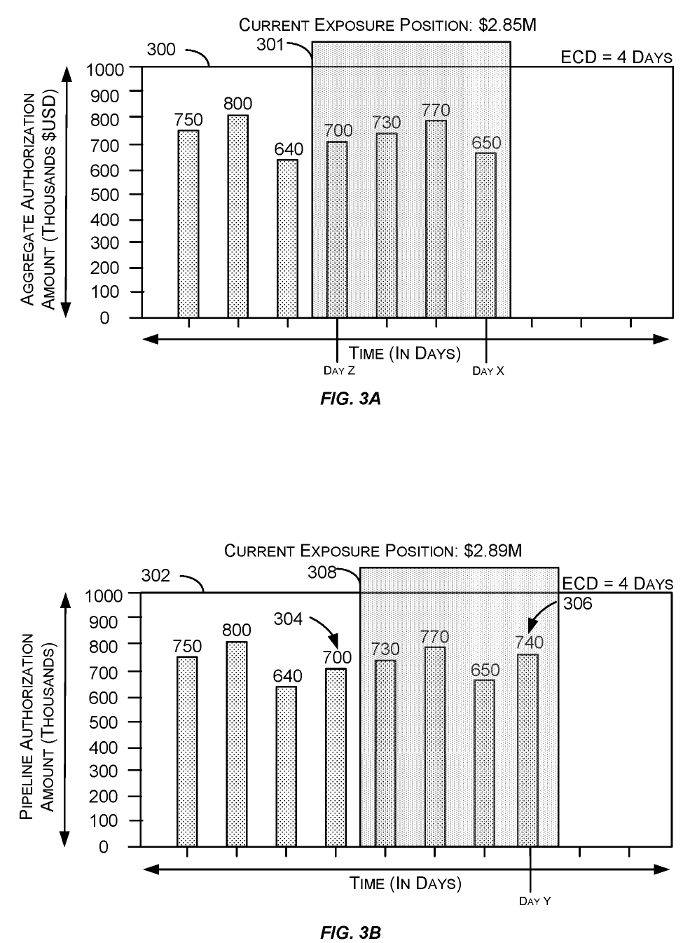

In an embodiment, current exposure position can be calculated by the transaction decisioning system by aggregating the client's authorization amounts over the number of days specified in the estimated clearing delay (ECD) parameter (stored in the settlement risk group object associated with the client). The ECD may be a sliding window calculation, in which the aggregated authorizations from the oldest processing day will be removed from the running total at the end of each processing day, as shown in FIGS. 3A and 3B. The transaction decisioning system may determine whether the current exposure position meets or exceeds one or more of the alerting threshold value, the throttling threshold value, or the maximum risk threshold value. If the current exposure position exceeds any one of such thresholds, the transaction decisioning system may execute further instructions to alert the payment processor, throttle future authorizations, or decline all future authorizations depending on the threshold value reached.

FIG. 3A is a graph illustrating the calculation of a current exposure position according to an embodiment of the invention. The graph 300 represents an ECD of four days (illustrated by shaded area 301) where the current exposure position is calculated near the end of the fourth day of the ECD period. In the example depicted, the transaction decisioning system would calculate the current exposure position by adding together each of the aggregate authorization amounts (e.g., the total payment obligations from each day) of each of the four days in the ECD period corresponding to the shaded area 301. Thus, the amounts of $700,000, $730,000, $770,000, and $650,000 would be added together to calculate a current exposure position of $2.85 million.

FIG. 3B is a graph illustrating the calculation of current exposure position at the end of a next processing day according to an embodiment of the invention. FIG. 3B is used to illustrate the sliding window calculation, in which the aggregated authorization amounts from the oldest processing day (e.g., corresponding to day 304) will be subtracted from the current exposure position and the most current day's totals (e.g., corresponding to day 306) may be added. Here, the shaded area 308 also represents an ECD of four days. In FIG. 3A, at the end of the day (e.g., 23:59:59 on day X) the current exposure position is $2.85M (e.g., the aggregation the exposure positions of day X and the previous 3 days ($700,000+$730,000+$770,000+$650,000)). However, at midnight (e.g., 00:00:00) the oldest day's (day Z's) volume may drop off (e.g., $700,000). Thus, the current exposure at midnight on day X is $2.15M (e.g., $730,000+$770,000+$650,000) As authorizations occur through the day on day Y of FIG. 3B, the current exposure position is incremented in real time and checked against the alerting, throttling, and maximum risk thresholds. At the end of the day (e.g., if $740,000 was the total amount processed for the day as depicted in FIG. 3B) then the current exposure position at 23:59:59 on day Y would be $2.89 million as shown in FIG. 3B.

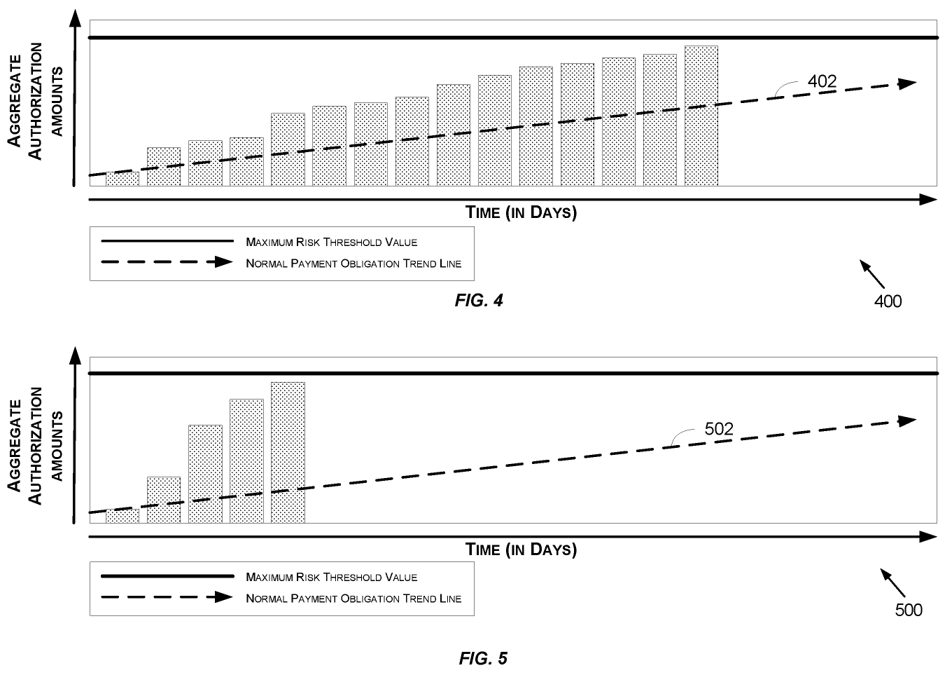

It should be appreciated that as the transaction decisioning system monitors authorization data flowing through the payment processor network it may detect unusual activity of the client. In some cases, the activity may not reach a particular threshold value (e.g., an alerting threshold value, a throttling threshold value, or a maximum risk threshold value), but may nonetheless be of interest to the payment processor. In at least one example, the transaction decision system may calculate a normal payment obligation trend based on historical transactions of the client (e.g., stored in the client risk profile). FIG. 4 is a graph illustrating daily payment obligations that are not indicative of suspicious activity, but represent higher transaction volumes than usual according to an embodiment of the invention. For example, the daily payment obligations of graph 400 indicate higher transaction volumes that usual (as indicated by the normal payment obligations trend line 402). However, given that the daily payment obligations roughly track with the normal payment obligations trend line 402, the transaction decisioning system may refrain from alerting the payment processor or from throttling/declining such authorizations. In at least some examples, when the daily payment obligations that are not indicative of suspicious activity but transactions exceed the maximum risk threshold, the transaction decisioning system could allow such transactions to proceed. In such cases, the transaction decisioning system may override any throttling/declining of transactions based on the analysis that the daily payment obligations are within some threshold of a normal trend line. In at least some examples, the payment processor may be notified by the transaction decisioning system to enable the payment processor to follow up with the client to investigate the higher transaction volumes.

Conversely, FIG. 5 is a graph illustrating daily payment obligations that may be indicative of suspicious activity according to an embodiment of the invention. The graph 500 may represent an abnormal spike in volume and may point to fraudulent or suspicious behavior by the client or client's cardholders. Upon analyzing the client's daily payment obligations, the transaction decisioning system may determine that one or more of the client's daily payment obligations are not tracking (within some threshold value) of the client's typical payment volumes (e.g., as indicated with normal payment obligations trend line 502). In this scenario, the transaction decisioning system can be configured to throttle/decline authorizations that meet or exceed a threshold value (e.g., 20% of normal payment obligations, $10,000 USD more than normal payment obligations, etc.) with respect to the normal payment obligations trend line 502. In some cases, the transaction decisioning system can decline authorizations based on detecting that the daily payment obligations are not tracking with the client's normal payment obligation behavior even when the maximum risk threshold may not have been reached. Additionally, or alternatively, the transaction decision system may inform the payment processor of the unusual behavior enabling the payment process to follow up with the client.

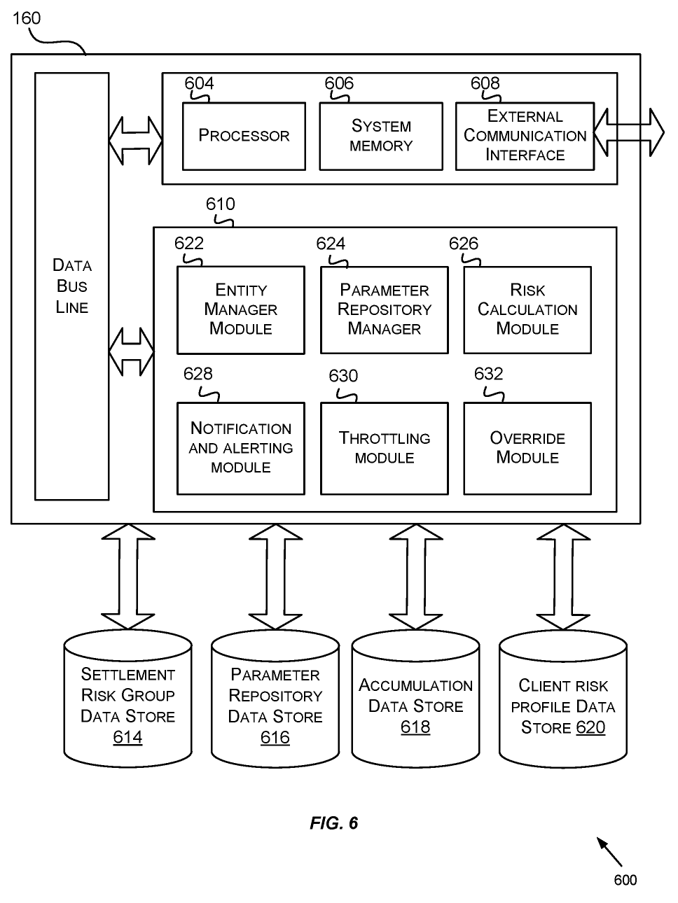

FIG. 6 is a block diagram of a computer architecture (e.g., for the transaction decisioning system 160 of FIG. 1) according to an embodiment of the invention. FIG. 6 shows the transaction decisioning system 160 communicatively couple to a number of data stores (e.g., a settlement risk group data store 614, a parameter repository data store 616, an accumulation data store 618, and a client risk profile data store 620. The data stores of FIG. 6 may be configured as depicted in FIG. 6, or the data stores may be provided, in whole or in part, as part of the transaction decisioning system 160.

The data stores of FIG. 6 (as well as any other database described herein) may be a conventional, fault tolerant, relational, scalable, secure database such as Oracle™ or Sybase™. The data stores of FIG. 6 may be implemented using various standard data-structures, such as an array, hash, (linked) list, structured text file (e.g., XML), table, and/or the like. Such data-structures may be stored in memory and/or in (structured) files.

The transaction decisioning system 160 may comprise a processor 604, which may be coupled to a system memory 606 and an external communication interface 608. A computer readable medium 610 may also be operatively coupled to the processor 604.

The computer readable medium 610 may comprise a number of software modules including an entity manager module 622, a parameter repository manager module 624, a risk calculation module 626, a notification and alerting module 628, a throttling module 630, and an override module 632. Although these various modules are depicted as being internal to the transaction decisioning system 160, any number of these modules may instead be implemented as separate systems external to the transaction decisioning system 160.

In at least one embodiment, the entity manager module 622 may comprise code that, when executed, causes the processor 604 to manage information related to one or more settlement risk group objects. A settlement risk group object may be associated with a settlement risk identifier. The settlement risk identifier may also be associated with several BINs. In at least one example, the entity manager module 622 may cause the processor 604 to receive information identifying and/or updating a settlement risk group. The entity manager module 622 may create and/or update a data object used for storing data related to a settlement risk group. The settlement risk group object may include at least one data field such as a settlement risk group identifier, an indicator to indicate whether domestic transactions must be accumulated separately (e.g., yes/no), a currency for domestic transactions, a cut-off time for domestic transactions (e.g., in GMT), an average number of clearing days—domestic (e.g., a number between 1 and 10), must be set if the domestic transactions must be accumulated separately indicator is set), an average number of clear days—international (e.g., a number between 1 and 10, 1 and 20, etc.), a monitor domestic exposure indicator, and a monitor non-domestic exposure indicator. All BINs that need to be grouped for an exposure determination may be associated with a common settlement risk group identifier. An exemplary settlement risk group object is shown below. Accordingly, each client associated with the settlement risk group identifier “ABC” can have its current exposure position calculated according to the data fields indicated below.

| Data Field Name | Value |
|---|---|
| Settlement Risk Group Identifier | ABC |
| Accumulate domestic separately | Y |
| Monitor Domestic | Y |
| Clearing Days | 3 |
| Domestic Currency | INR |
| Domestic Cut-off | 02:00 GMT |
| Issuer Country | INDIA |

In some embodiments, the accumulate domestic separately data field is a boolean value where true (Y) indicates that domestic transactions should be accumulated separately from international transactions and where false (N) indicates that domestic and international transactions should be accumulated together. The monitor domestic data field, also a boolean, indicates, when true, that domestic transactions should be accumulated or, when false, that domestic transactions should not be accumulated. The clearing days data field indicates an estimated number of days (e.g., an average of how many days are needed for clearing). The clearing days data field may be used to determine how many days for which daily amounts of the client's payment obligations should be aggregated to determine the client's current exposure position. The domestic currency data field indicates a type of currency for which domestic transactions will be reported. This field may be used by the transaction decision system when determining currency conversions (e.g., INR to USD). The domestic cut-off data field indicates a time and a time zone. Transactions occurring prior to the designated time will be included in suitable calculations performed by the transaction decisioning system while transactions occurring after the designated time will be excluded, The issuer country data field indicates a country of origin for the issuer.

Some embodiments of the invention allow the monitor domestic exposure indicator to be turned off via manual override. In some examples, the monitor domestic exposure indicator is defaulted to “no.” If the monitor domestic exposure indicator is set to “yes,” the indicator related to whether domestic transactions must be accumulated separately may be required to be set to “yes” and the cut-off time for domestic transactions and accumulation currency for domestic transaction may be required to be entered.

In at least one embodiment, the entity manager module 622 may cause the processor 604 to store a settlement risk group object in the settlement risk group data store 614. Further, the entity manager module 622 may cause the processor 604 to store, in a settlement risk group object or another suitable record, associations between one or more BINs and a settlement risk group identifier.

In at least one embodiment, the parameter repository manager module 624 may comprise code that, when executed, causes the processor 604 to manage a parameter repository (e.g., one or more records) that indicates how transactions will be declined when a threshold is reached. A parameter repository may be associated with, for example a settlement risk group identifier. In at least one example, the parameter repository can include an amount threshold (e.g., transactions under the amount can be automatically approved, transactions over the amount can be automatically declined), transaction priority (e.g., allow ATM cash disbursements, decline point of sale transactions), merchant category code (MCC) allowances (e.g., approve transactions from hospital services, grocery, transportation), or a risk score threshold (e.g., approve transactions below a particular risk score). In an embodiment, the parameter may also contain account numbers for which the associated transactions are always approved.

In at least one embodiment, the parameter repository manager module 624 may cause the processor 604 to receive configuration information indicating one or more alerting thresholds, one or more throttling thresholds, and/or a maximum exposure threshold. In at least one example, such thresholds may be defined by the payment processor or at least some of the thresholds may be calculated by the risk calculation module 626 discussed below. Each threshold may, in some examples, be associated with one or more actions. Such information may be stored by the processor 604 in the parameter repository data store 616.

As a non-limiting example, the parameter repository manager module 624 may cause the processor 604 to receive information defining one or more alerting threshold values. One alerting threshold value may correspond to a percentage (e.g., 75%, 85%, etc.) of a maximum risk threshold value (e.g., $25,000 USD). In another example, an alerting threshold value may correspond to an monetary amount (e.g., $10,000 USD). In some cases, the risk calculation module 626 may cause the processor 604 to execute instructions that determine that a current exposure position is greater than or equal to the alerting threshold value. Upon such a determination, the processor 604 may trigger one or more communications (e.g., an email) alerting a user that the alerting threshold value has been reached. As a further example, a throttling threshold may correspond to a particular monetary value (e.g., $10,000 USD) or a percentage (e.g., 80%, 60%, etc.) of a maximum risk threshold value. A current exposure position greater than or equal to a throttling threshold may cause the processor 604 to execute instructions that will decline one or more transactions. In at least one example, throttling may be further based on the transaction amount, a transaction type, MCC allowances, an account number, a risk score (e.g., a risk quotient), and the like.

As a non-limiting example, a parameter repository can include an alerting threshold of $10,000, a throttling threshold of $25,000, and a maximum risk threshold of $50,000 associated with a settlement risk group identifier. The parameter repository may further include an exposure increment (e.g., corresponding to an amount of non-authorized transactions per day) and an exposure decrement (e.g., corresponding to an amount of reversals/chargebacks per day). An exposure increment and an exposure decrement may be predefined or they may be calculated by the processor 604 as part of the functionality of the risk calculation module 626. An exposure decrement may correspond to an expected monetary amount of chargebacks/returns expected for the day (e.g., based on historical transactions of the client). An exposure increment may correspond to an expected monetary amount of non-authorized transactions expected for the day (e.g., based on historical transactions of the client.) The exposure increment and exposure decrement may be used to adjust each threshold value. For example, given an exposure increment of $1000 (in non-authorized transactions that will increase the current exposure position of the client) and an exposure decrement of $500 (in expected returns that will decrease the current exposure position) the net exposure adjustment will be a $500 dollar increase. Accordingly, the alerting threshold may be decreased to $9,500, the throttling threshold may be decreased to $24,500, and the maximum risk threshold may be decreased to $49,500, respectively in order to accommodate the expected increase of financial obligations resulting from the combination of expected non-authorized transactions and reversals/chargebacks.

In at least one embodiment, the parameter repository manager module 624 may cause the processor 604 to modify one or more parameters to after a threshold period of time (e.g., 60 days). In at least one example, modification of a parameter may cause the processor to execute instructions to provide a communication (e.g., an email) alerting the payment processor to the change. In some examples, the payment processor may be enabled to reactivate the parameter (e.g., via a option included in the email).

In at least one embodiment, the risk calculation module 626 may cause the processor 604 to execute instructions that maintain a client risk profile associated with a client. In at least one example, the instructions included in the risk calculation module 626 may utilize available data from sources such as regulatory bodies and/or ratings agencies along with historical transaction volumes for risk quotient calculations of a client.

In at least one embodiment, the risk calculation module 626 may cause the processor 604 to execute instructions that utilize a model to calculate a risk quotient. The model may take in as input at least one of client capital, asset quality, client liquidity, an amount of collateral, and the like. In at least one example, the model may include transaction history (both domestic and cross-border) from multiple sources including the payment processor's processed transactions and operating certificates. The model can also include acquirer payment practices, including an average elapsed time between authorization and submission of clearing files. The model may also incorporate the performance of the settlement agent. The model may also accommodate varying levels of information availability, differing banking practices, and other region or country-specific practices. Upon calculating a risk quotient, the risk calculation module 626 may cause the processor 604 to store the risk quotient in the client risk profile within the client risk profile data store 620.

In at least one example, the risk calculation module 626 may cause the processor 604 to calculate a maximum risk threshold value based on the risk quotient. In some examples, the maximum risk threshold value incorporates the delay between the authorization and clearing of the client (e.g., the ECD). In some examples, the risk calculation module 626 may cause the processor 604 to update the parameter repository for the client with the calculated maximum risk threshold value. Similarly, instructions may be executed by the processor 604 to calculate and store an alerting threshold value and/or a throttling threshold value.

In at least one embodiment, the risk calculation module 626 may cause the processor 604 to execute instructions that accumulate (e.g., collect) and aggregate (e.g., add) transaction amounts to calculate a real-time payment obligation (e.g., a current exposure position) of a client. For example, the real-time payment obligation may be based on determining the sum of daily authorization totals, S, for day-1 to day-x (where x may be a number of days associated with an ECD) and a current day's authorization total, C. When the real-time payment obligation calculation exceeds (or equals) an alerting threshold value, the notification and alerting module 628 may cause the processor 604 to send a communication (e.g., an email, text message, etc.) to the payment processor to alert the payment processor that a current exposure position has reached a particular amount. When the real-time payment obligation calculation exceeds (or equals) a throttling threshold, the throttling module 630 may cause the processor 604 to execute instructions which cause one or more authorization messages to be declined. In this manner, financial exposure of the payment processor is reduced. The determination of whether to decline authorization messages can be based on conditions (e.g., transaction priority algorithms, business rules) contained in the parameter repository. As described above in connection with the parameter repository manager module 624, the client may customize the conditions to help determine when authorization messages should be declined. When the real-time payment obligation calculation exceeds (or equals) a maximum exposure threshold value, the throttling module 630 may cause the processor 604 to execute instructions that cause all authorization messages to be declined in order to prevent further financial exposure to the payment processor.

In at least one embodiment, the risk calculation module 626 may also distinguish between normal volume fluctuations and suspicious client behavior by comparing information from the client risk profile and the maximum risk threshold value. In at least one example, the risk calculation module 626 may cause the processor 604 to execute instructions to determine a normal payment obligation trend line for the client. For example, the normal payment obligation trend line may indicate an historical average of daily aggregated amounts for a same time period in the past. For a typical client, the client's current daily transaction volumes may be well below the maximum risk threshold value on a given day. However, intra-day fluctuations and spikes may occasionally push calculated payment obligations over the normal payment obligation trend line (e.g., some amount or percentage higher than the historical average for that day), but may not be indicative of suspicious behavior, as is illustrated in FIG. 4.

In order to determine whether the fluctuations in daily payment obligations are fraudulent or allowable, the risk calculation module 626 may cause the processor 604 to execute instructions that analyze volume trends and other data to determine whether the transactions that exceed the maximum risk threshold should be allowed to proceed. The risk calculation module 626 can cause the processor 604 to execute instructions that analyze the client's average payment obligation, timing of the client's fund collections, and peak season considerations (e.g., Black Friday).

In at last one embodiment, the risk calculation module 626 may cause the processor 604 to execute instructions that manage a table or other suitable record related to accumulation amounts for a client. In a non-limiting example, the table or record may include a set of aggregate values associated with a total domestic authorized amount, a domestic date corresponding to the domestic authorized amount, a non-domestic total authorized amount, and a non-domestic date associated with the non-domestic total authorized amount. IN at least one embodiment, the risk calculation module 626 may cause the processor 604 to store such a record/table in the accumulation data store 618.

As a non-limiting example, a sample aggregation is provided below. Assume that a client is associated with a settlement risk group identifier “ABC.” The settlement risk group object corresponding to the settlement risk group identifier “ABC,” is:

| | |
|---|---|
| Settlement Risk group ID | ABC |
| Accumulate domestic separately | Y |
| Monitor Domestic | Y |
| Clearing Days | 3 |
| Domestic Currency | INR |
| Domestic Cut-off | 02:00 GMT |
| Issuer Country | INDIA |

It should be appreciated, for the purposes of the example below that the non-domestic cutoff time may be defined as 10:00 GMT. This may be predefined or modifiable by the user and may be used for processing non-domestic transactions.

A number of sample transactions involving BINs belonging to the settlement risk group identifier “ABC,” are provided in the following table.

| Transaction | Transaction | Acquirer | Merchant | Transaction |
|---|---|---|---|---|
| Date | Amount | Country | Country | Time |
| Sep. 16, 2013 | 500 INR | INDIA | INDIA | 23:00 GMT |
| Sep. 16, 2013 | 1000 INR | NEPAL | NEPAL | 23:30 GMT |
| Sep. 17, 2013 | 50 USD | INDIA | INDIA | 00:00 GMT |
| Sep. 17, 2013 | 300 INR | INDIA | INDIA | 01:30 GMT |
| Sep. 17, 2013 | 5000 INR | INDIA | INDIA | 02:30 GMT |
| Sep. 17, 2013 | 75 USD | INDIA | INDIA | 08:00 GMT |
| Sep. 17, 2013 | 130 USD | INDIA | INDIA | 10:30 GMT |

Prior to processing any of the transactions below. A table may be initialized as follows (‘−’=null):

| | | | Non- | Non- |
|---|---|---|---|---|
| | Domestic | Domestic | Domestic | Domestic |
| | Total | Date | Total | Date |
| Current Day | 0 | — | 0 | — |
| Current Day - 1 | 0 | — | 0 | — |
| Current Day - 2 | 0 | — | 0 | — |

It should be appreciated that the table includes columns for domestic and non-domestic totals/dates as a result of the accumulate domestic separately data field of the corresponding settlement risk group object being set to true (Y).

A first transaction may be processed and the table updated as indicated below.

### 1^{st} Transaction (Domestic, Central Processing Date (CPD)=9/17/2013)

| Transaction | Transaction | Acquirer | Merchant | Transaction |
|---|---|---|---|---|
| Date | Amount | Country | Country | Time |
| Sep. 16, 2013 | 500 INR | INDIA | INDIA | 23:00 GMT |

| | | | Non- | Non- |
|---|---|---|---|---|
| | Domestic | Domestic | Domestic | Domestic |
| | Total | Date | Total | Date |
| Current Day | 500 | Sep. 17, 2013 | 0 | — |
| Current Day - 1 | 0 | — | 0 | — |
| Current Day - 2 | 0 | — | 0 | — |

Current Exposure Domestic = 500 INR (Provided in INR according to the domestic currency data field of the settlement risk group object)
Current Exposure International = 0

A second transaction may be processed and the table updated as indicated below.

### 2nd Transaction (Non-Domestic, CPD 9/17/2013, Convert to USD)

| Transaction | Transaction | Acquirer | Merchant | Transaction |
|---|---|---|---|---|
| Date | Amount | Country | Country | Time |
| Sep. 16, 2013 | 1000 INR | NEPAL | NEPAL | 23:30 GMT |

| | | | Non- | Non- |
|---|---|---|---|---|
| | Domestic | Domestic | Domestic | Domestic |
| | Total | Date | Total | Date |
| Current Day | 500 | Sep. 17, 2013 | 15.78 | Sep. 17, 2013 |
| Current Day - 1 | 0 | — | 0 | — |
| Current Day - 2 | 0 | — | 0 | — |

Current Exposure Domestic = 500 INR
Current Exposure Non-Domestic = 15.78 USD (Converted to USD)

A third transaction may be processed and the table updated as indicated below.

### 3rd Transaction (Non-Domestic, CPD 9/17/2013)

| Transaction | Transaction | Acquirer | Merchant | Transaction |
|---|---|---|---|---|
| Date | Amount | Country | Country | Time |
| Sep. 17, 2013 | 50 USD | INDIA | INDIA | 00:00 GMT |

| | | | Non- | Non- |
|---|---|---|---|---|
| | Domestic | Domestic | Domestic | Domestic |
| | Total | Date | Total | Date |
| Current Day | 500 | Sep. 17, 2013 | 65.78 | Sep. 17, 2013 |
| Current Day - 1 | 0 | — | 0 | — |
| Current Day - 2 | 0 | — | 0 | — |

Current Exposure Domestic = 500 INR
Current Exposure Non-Domestic = 65.78 USD (Converted to USD and aggregated with previous amount)

A fourth transaction may be processed and the table updated as indicated below.

### 4th Transaction (Domestic, CPD 9/17/2013)

| Transaction | Transaction | Acquirer | Merchant | Transaction |
|---|---|---|---|---|
| Date | Amount | Country | Country | Time |
| Sep. 17, 2013 | 300 INR | INDIA | INDIA | 01:30 GMT |

| | | | Non- | Non- |
|---|---|---|---|---|
| | Domestic | Domestic | Domestic | Domestic |
| | Total | Date | Total | Date |
| Current Day | 800 | Sep. 17, 2013 | 65.78 | Sep. 17, 2013 |
| Current Day - 1 | 0 | — | 0 | — |
| Current Day - 2 | 0 | — | 0 | — |

Current Exposure Domestic = 800 INR (Aggregated to previous amount)
Current Exposure Non-Domestic = 65.78 USD

A fifth transaction may be processed and the table updated as indicated below. Because the fifth transaction is after the domestic cut-off time indicated in the settlement risk group object, the transaction amount will be attributed to the next day.

### 5th Transaction (Domestic, CPD 9/18/2013 (Due to Domestic Cutoff Time))

| Transaction | Transaction | Acquirer | Merchant | Transaction |
|---|---|---|---|---|
| Date | Amount | Country | Country | Time |
| Sep. 17, 2013 | 5000 INR | INDIA | INDIA | 02:30 GMT |

| | | | Non- | Non- |
|---|---|---|---|---|
| | Domestic | Domestic | Domestic | Domestic |
| | Total | Date | Total | Date |
| Current Day | 5000 | Sep. 18, 2013 | 65.78 | Sep. 17, 2013 |
| Current Day -1 | 800 | Sep. 17, 2013 | 0 | — |
| Current Day - 2 | 0 | — | 0 | — |

Current Exposure Domestic = 5800 INR (aggregate of the amount within the ECD period)
Current Exposure Non-Domestic = 65.78 USD

A sixth transaction may be processed and the table updated as indicated below.

### 6th Transaction (Non-Domestic, CPD 9/17/2013)

| Transaction | Transaction | Acquirer | Merchant | Transaction |
|---|---|---|---|---|
| Date | Amount | Country | Country | Time |
| Sep. 17, 2013 | 75 USD | INDIA | INDIA | 08:00 GMT |

| | | | Non- | Non- |
|---|---|---|---|---|
| | Domestic | Domestic | Domestic | Domestic |
| | Total | Date | Total | Date |
| Current Day | 5000 | Sep. 18, 2013 | 140.78 | Sep. 17, 2013 |
| Current Day - 1 | 800 | Sep. 17, 2013 | 0 | — |
| Current Day - 2 | 0 | — | 0 | — |

Current Exposure Domestic = 5800 INR
Current Exposure Non-Domestic = 140.78 USD (Note: this transaction may qualify as Non-Domestic because it was not processed in the local currency of INR)

A seventh transaction may be processed and the table updated as indicated below. Because the fifth transaction is after the domestic cut-off time indicated in the settlement risk group object, the transaction amount will be attributed to the next day.

### 7th Transaction (Non-Domestic, CPD 9/18/2013 (Due to Non-Domestic Cutoff Time))

| Transaction | Transaction | Acquirer | Merchant | Transaction |
|---|---|---|---|---|
| Date | Amount | Country | Country | Time |
| Sep. 17, 2013 | 130 USD | INDIA | INDIA | 10:30 GMT |

| | | | Non- | Non- |
|---|---|---|---|---|
| | Domestic | Domestic | Domestic | Domestic |
| | Total | Date | Total | Date |
| Current Day | 5000 | Sep. 18, 2013 | 130.00 | Sep. 18, 2013 |
| Current Day - 1 | 800 | Sep. 17, 2013 | 140.78 | Sep. 17, 2013 |
| Current Day - 2 | 0 | — | 0 | — |

Current Exposure Domestic = 5800 INR
Current Exposure Non-Domestic = 270.78 USD

In at least one embodiment, the notification and alerting module 628 may cause the processor 604 to execute instructions that alert the payment processor when its payment obligation exceeds one or more risk threshold values. The payment processor may use the alerts to take prompt action to prevent additional risks before the transactions are throttled. The alerts may also assist the payment processor so that the payment processor can request additional collateral or other forms of indemnification from the client. The notification and alerting module 628 can cause the processor 604 to maintain a database of individuals to receive alerts. In an embodiment, the alerts can consist of text messages, e-mails, and the like.

In at least one embodiment, the override module 632 may cause the processor 604 to execute instructions to enable a transaction to proceed that otherwise would have been declined for various reasons. In at least one example, the override module 632 may cause the processor 604 to receive information (e.g., from the payment processor) indicating that a particular transaction should be allowed to proceed. In at least one embodiment, an override operates in real-time and may lapse after a threshold period of time (e.g., 24 hours, 3 hours, 4 days, 15 minutes, etc.). In some examples, the override correspondings to all threshold values (e.g., alerting, throttling, etc.) while in other examples, a separate override may be provided that corresponds to one or more threshold values. In at least one embodiment, the override module 632 cause the processor 604 to disable fluctuations checking, for example, during transaction throttling.

Further, embodiments of the invention may apply one or more of the aforementioned features of the transaction decisioning system differently for each client. For example, if the client is a well-established, investment-grade bank, the payment processor can forego the collateral or subsequent risk analysis. The client's status as a well-established bank can be shown as an indicator or flag in the transaction decisioning system. When the indicator is activated, the risk analysis may be applied to the client's transactions. In an embodiment, the indicator can be selected for example, at a bank identification number (BIN) level, etc.

The various participants and elements described herein may operate one or more computer apparatuses to facilitate the functions described herein. Any of the elements in the above-described Figures, including any servers or databases, may use any suitable number of subsystems to facilitate the functions described herein.

The subsystems discussed herein may be interconnected via a system bus. Additional subsystems such as a printer, a keyboard, a fixed disk (or other memory comprising computer readable media), a monitor (which may be coupled to display adapter), and others subsystems may be utilized. Peripherals and input/output (I/O) devices, which may be couple to an I/O controller (which can be a processor or other suitable controller), can be connected to the computer system by any number of means known in the art, such as serial port. For example, a serial port or an external interface can be used to connect the computer apparatus to a wide area network such as the Internet, a mouse input device, or a scanner. The interconnection via system bus may allow the central processor to communicate with each subsystem and to control the execution of instructions from system memory or from a fixed disk, as well as the exchange of information between subsystems. The system memory and/or the fixed disk may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

### TECHNICAL BENEFITS

Embodiments of the invention provide a number of technical advantages. These technical advantages can help minimize the risk related to indemnifying electronic payment transactions, for example, when authorization and clearing are processed by the indemnifier. By allowing a payment processor to throttle and/or monitor authorization messages for a client and essentially create a ceiling of allowable transaction amounts, the payment processor can help mitigate internal fraud. Additionally, these techniques can serve as a second check for an issuer bank's authorization process. The payment processor can also determine when an excessive amount of money is withdrawn within a short amount of time that would otherwise be uncharacteristic of an account at the issuer bank, to help further mitigate financial risk.

As a non-limiting example of the benefits of the techniques described above, if a massive run of fraudulent activity occurs (e.g., organized ATM cash out), the combined activity may cause one or more throttling/declining thresholds to be exceeded. Since the transactions are declined, there is no further processing required. However, in the absence of the system and methods provided herein, these transactions would get forwarded to the issuer for approval and would subsequently be cleared and settled. Upon noticing fraudulent activity on statements, cardholders would charge these transactions back to the issuer, who would submit dispute transactions through the payment processor. Thus, the techniques discussed herein eliminate the entire dispute cycle.

Further, by throttling authorization responses based upon a particular risk (e.g., insolvency), a payment processing system can continue to run efficiency, while minimizing transaction processing that otherwise might occur. By declining an authorization message destined for an issuer unable to pay its settlement obligations, the techniques described above can decrease the processing required to settle the transaction. If the transaction is declined, no further action is required, as a declined authorization does not add to a settlement obligation.

What is claimed is:

1. A method comprising:
determining, by a computer, an amount of collateral associated with a participation in a program by a financial institution;
calculating, by a computer, a risk threshold value for the financial institution based at least in part on the amount of collateral; and
declining, by a computer, authorization request messages from a payment processing network based at least in part on determining that an aggregated amount of previously-authorized transaction amounts exceeds the risk threshold value.

2. The method of claim 1, further comprising:
maintaining a risk profile for the financial institution, the risk profile comprising historical transaction information of the financial institution, wherein determining the risk threshold value is further based at least in part on the risk profile of the financial institution.

3. The method of claim 2, further comprising:
modifying the historical transaction information of the risk profile based at least in part on the estimated clearing delay value; and
calculating a new risk threshold value based at least in part on the modified historical transaction information.

4. The method of claim 1, wherein the risk threshold value is determined utilizing a statistical model, the statistical model utilizing at least one attribute associated with the financial institution, the financial institution being associated with a set of attributes comprising at least one of capital, asset quality, liquidity, or collateral.

5. The method of claim 4, wherein the statistical model further utilizes historical transaction information of the financial institution.

6. The method of claim 1, further comprising:
adjusting an aggregate amount of previously authorized transaction amounts based at least in part on at least one of reversal transactions, merchandise credit transactions, or chargeback transactions.

7. The method of claim 1, wherein declining authorizations from the payment processing network is further based at least in part on an estimated clearing delay associated with the financial institution.

8. The method of claim 1, wherein declining the authorization request message is further based at least in part data associated with the authorization request message, the data including at least one of a transaction amount, a transaction type, a merchant category code, or an account number.

9. The method of claim 1, further comprising:
determining a normal financial payment trend associated with the financial institution based at least in part on historical transaction information of the financial institution;
receiving an authorization request message involving the financial institution; and
declining the authorization request message based at least in part on the normal financial payment trend associated with the financial institution.

10. The method of claim 1, further comprising:
providing an alert when the risk threshold value exceeds a configurable alerting threshold.

11. A computer comprising,
a processor, and
a computer readable medium coupled to the processor, the computer readable medium comprising code for causing the processor to:
determine an amount of collateral associated with a participation in a program by a financial institution;
calculate a risk threshold value for the financial institution based at least in part on the amount of collateral; and
decline authorization request messages from a payment processing network based at least in part on determining that an aggregated amount of previously-authorized transaction amounts exceeds the risk threshold value.

12. The computer of claim 11, wherein the computer readable medium comprises additional code for causing the processor to:
maintain a risk profile for the financial institution, the risk profile comprising historical transaction information of the financial institution, wherein determining the risk threshold value is further based at least in part on the risk profile of the financial institution.

13. The computer of claim 12, wherein the computer readable medium comprises additional code for causing the processor to:
modify the historical transaction information of the risk profile based at least in part on the estimated clearing delay value; and
calculate a new risk threshold value based at least in part on the modified historical transaction information.

14. The computer of claim 11, the risk threshold value is determined utilizing a statistical model, the statistical model utilizing at least one attribute associated with the financial institution, the financial institution being associated with a set of attributes comprising at least one of capital, asset quality, liquidity, or collateral.

15. The computer of claim 14, wherein the statistical model further utilizes historical transaction information of the financial institution.

16. The computer of claim 11, wherein the computer readable medium comprises additional code for causing the processor to:
adjust an aggregate amount of previously authorized transaction amounts based at least in part on at least one of reversal transactions, merchandise credit transactions, or chargeback transactions.

17. The computer of claim 11, wherein declining authorizations from the payment processing network is further based at least in part on an estimated clearing delay associated with the financial institution.

18. The computer of claim 11, wherein declining the authorization request message is further based at least in part data associated with the authorization request message, the data including at least one of a transaction amount, a transaction type, a merchant category code, or an account number.

19. The computer of claim 11, wherein the computer readable medium comprises additional code for causing the processor to:
determine a normal financial payment trend associated with the financial institution based at least in part on historical transaction information of the financial institution;
receive an authorization request message involving the financial institution; and
decline the authorization request message based at least in part on the normal financial payment trend associated with the financial institution.

20. The method of claim 1, further comprising:
providing an alert when the risk threshold value exceeds a configurable alerting threshold.
